(19) United States
(12) Patent Application Publication
(10) Pub. No.: US 2013/0179610 A1
(43) Pub. Date: Jul. 11, 2013

(54) USB DEVICE WITH PASS-THROUGH HUB CONNECTION

(71) Applicants: David Smurthwaite, Alamo, CA (US); Jon Anderson, Alamo, CA (US); Daniel Hogan, Alamo, CA (US)

(72) Inventors: David Smurthwaite, Alamo, CA (US); Jon Anderson, Alamo, CA (US); Daniel Hogan, Alamo, CA (US)

(73) Assignee: Kleer LTD, Alamo, CA (US)

(21) Appl. No.: 13/347,606

(22) Filed: Jan. 10, 2012

(51) Int. Cl. G06F 13/12; H01R 27/02

(52) U.S. Cl. 710/63; 439/638

(57) ABSTRACT

A portable USB device is described herein. The portable USB device such as a storage drive or a card reader has a built-in pass-through hub connection. Instead of clogging up the USB port availability of a computer or other host device, the device provides an extra USB female receptacle on the device to allow the computer to flow information or power charge to another USB device connected to the female receptacle.

### FIELD OF THE INVENTION

The present invention relates to a universal serial bus (“USB”) device and more particularly, to a USB storage drive or a USB card (memory card, game card, etc.) reader having a pass-through USB hub connection.

### BACKGROUND

A USB storage drive (also referred to as USB drive) is a data storage device having an integrated USB interface. One of the most common types of USB storage drives is USB flash drive, which contains flash memory for storing data. USB drives are usually rewritable and physically smaller than conventional storage devices. A USB drive contains a small printed circuit board (“PCB”) controlling a USB connector, usually a USB male plug. When connected to a computer, a USB drive may draw power from the computer via the USB connector. Typically USB drives use the USB mass storage device class protocol to communicate with the host computer. A small microcontroller with a small amount of on-chip ROM and RAM, called USB mass storage controller, is built on the PCB board in the drive.

A USB memory card reader typically has a USB interface for accessing data on a memory card, such as a CompactFlash (“CF”), a memory stick (“MS”), a Secure Digital (“SD”), a miniSD, or a microSD card. Similar to a USB flash drive, a USB memory card reader has a USB card reader controller to control the USB connection functionality of the device. Furthermore, a USB memory card reader contains circuitry and one or more memory card insertion slots to accommodate and access one or more types of memory cards. An example of a USB memory card reader is disclosed in U.S. Patent Publication 2009/0255991. Such USB devices clog up the limited USB ports on computers and are solely for the purpose for providing memory card read/write capability.

A computer has a limited number of USB ports. Nowadays, USB interfaces are utilized by a large number of computer peripheral devices, such as external storage device, printer, scanner, keyboard, mouse, joystick, webcam, digital camera, mobile phone, and card reader. It is a common situation that all USB ports are occupied with devices while another USB device needs to be connected to the computer. Although USB hubs can be plugged into a computer to expand the number of USB ports, it is not convenient to carry an extra device and acquiring such an extra device increases cost.

The foregoing examples of the related art and limitations related therewith are intended to be illustrative and not exclusive. Other limitations of the related art will become apparent upon a reading of the specification and a study of the drawings.

### SUMMARY

Introduced herein is a portable USB device such as a storage drive or a card reader having a built-in pass-through hub connection. Instead of clogging up the USB port availability of a computer, car stereo, gaming console, entertainment center, other host device, or other supporting accessory, the portable USB device provides an extra USB female receptacle on the device to allow the computer to flow information or power charge to another USB device connected to the female receptacle. The card reader can work with a variety of suitable cards, depending upon the implementation, such as a memory card, a game card, etc.

According to one embodiment, there is provided a USB storage drive comprising a memory unit, a USB male plug, a USB female receptacle and a controller. The USB male plug is adapted to be inserted into a USB port. The USB female receptacle is adapted to connect to USB devices. The controller is electrically coupled to the USB male plug, the USB female receptacle and the memory unit. The controller is configured to function as a USB mass storage controller when the USB female receptacle is not connected to any USB peripherals. The controller is further configured to function as a USB hub controller when the USB female receptacle is connected to a USB peripheral.

According to a related embodiment, the memory unit has a first memory size; when an additional USB storage drive having a second memory size is connected to the USB female receptacle, the controller is configured to function as a USB interface for a virtual memory having a combined memory size as a summation of the first memory size and the second memory size. According to another related embodiment, when the additional USB storage drive has a USB female receptacle connected to one or more extra USB storage drives, the controller is configured to function as a USB interface for a virtual memory having a combined memory size as a summation of memory sizes of the USB storage drive, the additional USB storage drive and the extra USB storage drives.

According to another embodiment, there is provided a USB memory card reader comprising a memory card slot, a USB male plug, a USB female receptacle, and a controller. The memory card slot is adapted to accommodate and connect to a memory card. The USB male plug is adapted to be inserted into a USB port. The USB female receptacle is adapted to connect to USB devices. The controller is electrically coupled to the USB male plug, the USB female receptacle and the memory card slot. The controller is configured to function as a card reader controller when the USB female receptacle is not connected to any USB peripherals. The controller is further configured to function as a USB hub controller when the USB female receptacle is connected to a USB peripheral.

According to a related embodiment, the memory card slot is adapted to connect to the memory card having a first memory size; when an additional USB storage drive having a second memory size is connected to the USB female receptacle, the controller is configured to function as a USB interface for a virtual memory having a combined memory size as a summation of the first memory size and the second memory size. According to another related embodiment, the additional USB storage drive has a USB female receptacle connected to one or more extra USB storage drives, and the controller s configured to function as a USB interface for a virtual memory having a combined memory size as a summation of memory sizes of the memory card, the additional USB storage drive and the extra USB storage drives.

This Summary is provided to introduce a selection of concepts in a simplified form that are further described below in the Detailed Description. This Summary is not intended to identify key features or essential features of the claimed subject matter, not is it intended to be used to limit the scope of the claimed subject matter.

### BRIEF DESCRIPTION OF THE DRAWINGS

One or more embodiments of the present invention are illustrated by way of example and are not limited by the figures of the accompanying drawings, in which like references indicate similar elements.

FIG. 1 illustrates an example of a USB storage drive with a built-in pass-through hub connection.

FIG. 2 is a front elevational view of an example of a USB storage drive.

FIG, 3 is a rear elevational view of an example of a USB storage drive.

FIG. 4 is a right side elevational view of an example of a USB storage drive.

FIG. 5 is a top plan view of an example of a USB storage drive.

FIG. 6 is a perspective view of an example of a USB storage drive, as seen from the front, right, top side.

FIG. 7 is a diagram of an exploded view for an example of a USB storage drive.

FIG. 8 is a block diagram of components of an example of a USB storage drive.

FIG. 9 is a block diagram of components of an example of a USB storage drive.

FIG. 10A-10C illustrates a swivel mechanism of an example of a USB storage drive.

FIG. 11 is a perspective view of an example of a USB storage drive with a swivel mechanism, as seen from the front, right, top side.

FIG. 12 is a front elevational view of a USB storage drive.

FIG. 13 is a rear elevational view of a USB storage drive.

FIG. 14 is a right side elevational view of a USB storage drive.

FIG. 15 is a perspective view of a USB storage drive, as seen from the rear, right, bottom side.

FIG. 16 illustrates an example of a USB memory card reader with a built-in pass-through hub connection.

FIG. 17 is a block diagram of components of an example of a USB memory card reader.

FIG. 18 is a block diagram of components of an example of a USB memory card reader.

### DETAILED DESCRIPTION

Various aspects of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description. Although the diagrams depict components as functionally separate, such depiction is merely for illustrative purposes. It will be apparent to those skilled in the art that the components portrayed in this figure may be arbitrarily combined or divided into separate components.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

References in this specification to “an embodiment,” “one embodiment,” or the like mean that the particular feature, structure, or characteristic being described is included in at least one embodiment of the present invention. Occurrences of such phrases in this specification do not necessarily all refer to the same embodiment.

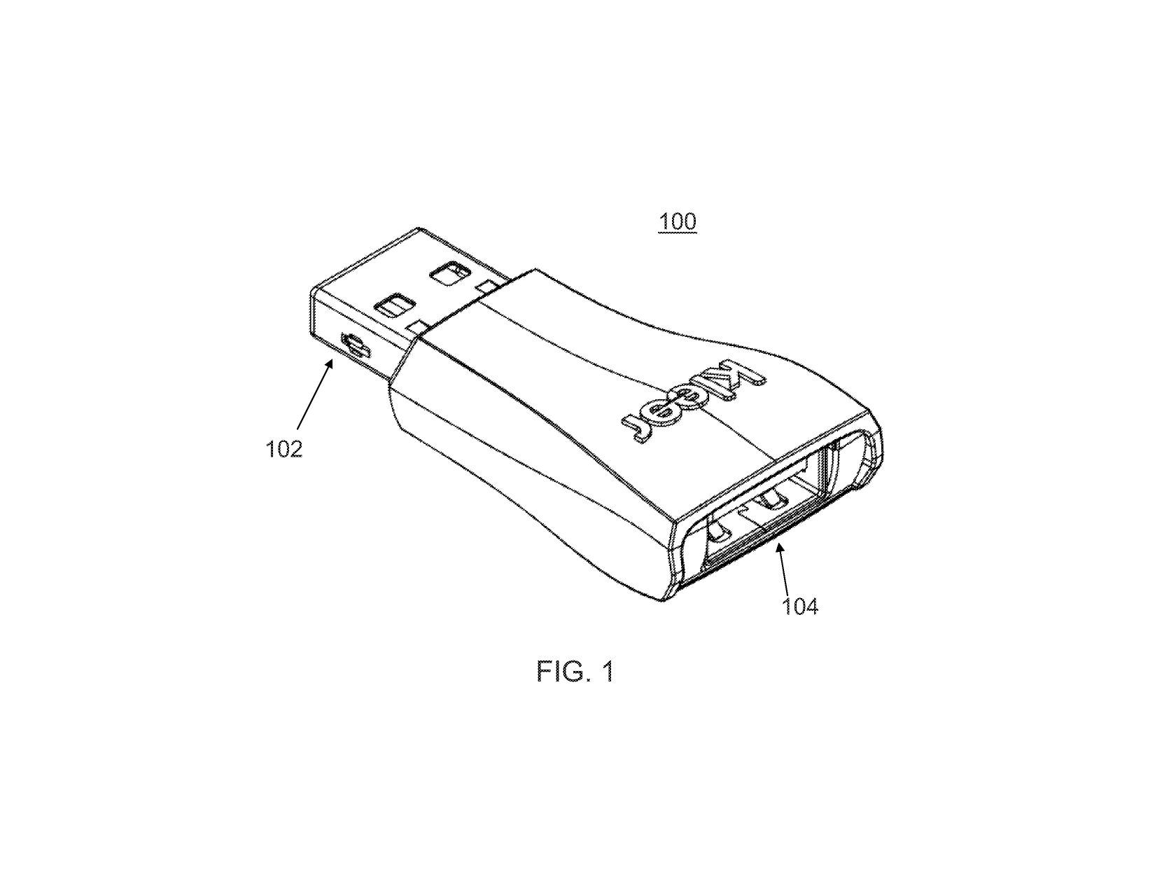

FIG, 1 illustrates an example of a USB storage drive 100 with a built-in pass-through hub connection, according to one embodiment of the present invention. FIG. 1 shows a perspective view of the drive 100, as seen from the rear, right, top side of the drive, The USB storage drive 100 includes a USB male plug 102 and at least one USB female receptacle 104. In the example as shown in FIG. 1, the USB female receptacle 104 is located at the opposite end of where the USB male plug 102 locates at the drive 100. In other embodiments, the USB female receptacle 104 may be located on a lateral side, a top side, or a bottom side of the drive 100. In some embodiments, there may be more than one USB female receptacle to be connected with more than one USB peripherals. In the example as shown in FIG. 1, the USB male plug 102 is a standard Type A USB male plug. In other embodiments, the USB male plug may be a Type B, Mini-A, Mini-B, Micro-A, Micro-B or any other types of USB 1.1, 2.0 or 3.0 male plug that an ordinary skilled person in the art readily utilizes on a USB plug. In the example as shown in FIG. 1, the USB female receptacle 104 is a standard Type A USB female receptacle. In other embodiments, the USB female plug may be a Type B, Mini-A, Mini-B, Micro-A, Micro-B or any other types of USB 1.1, 2.0 or 3.0 female receptacle that an ordinary skilled person in the art readily utilizes on a USB receptacle.

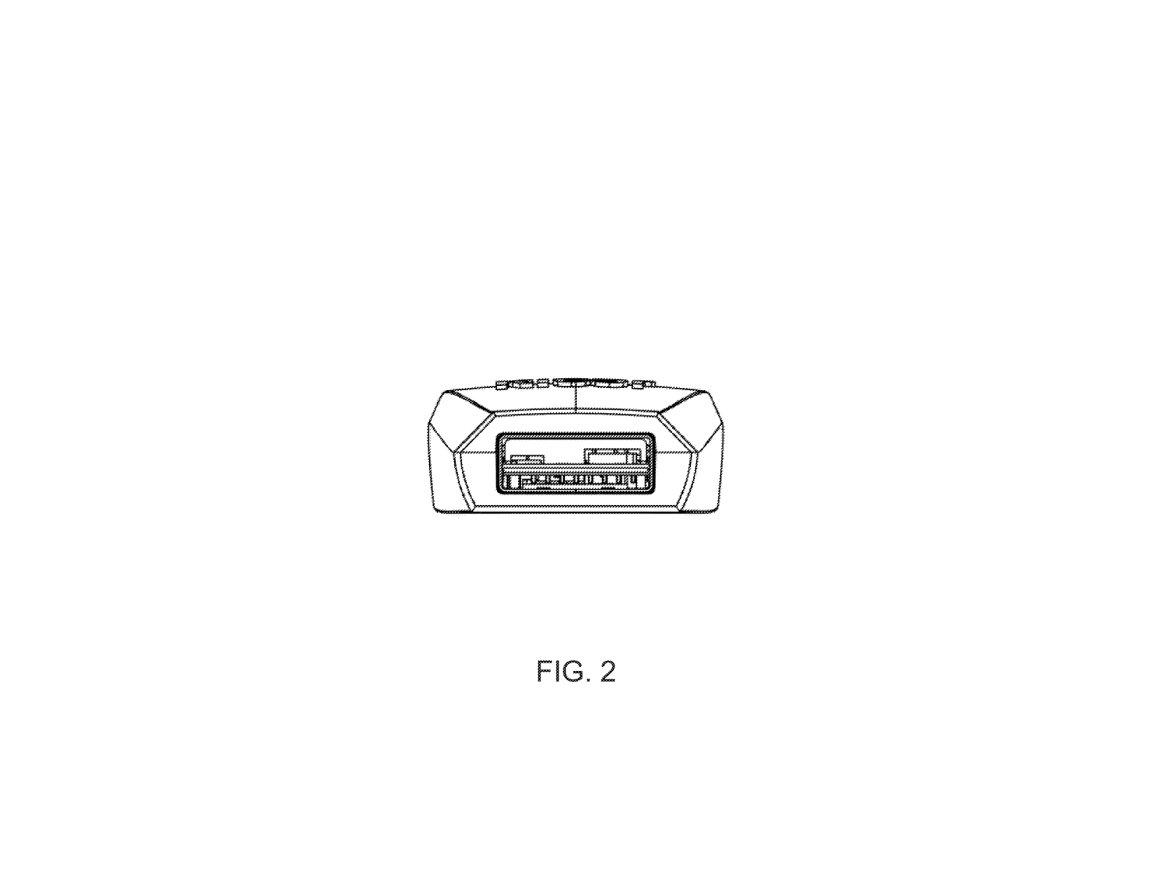

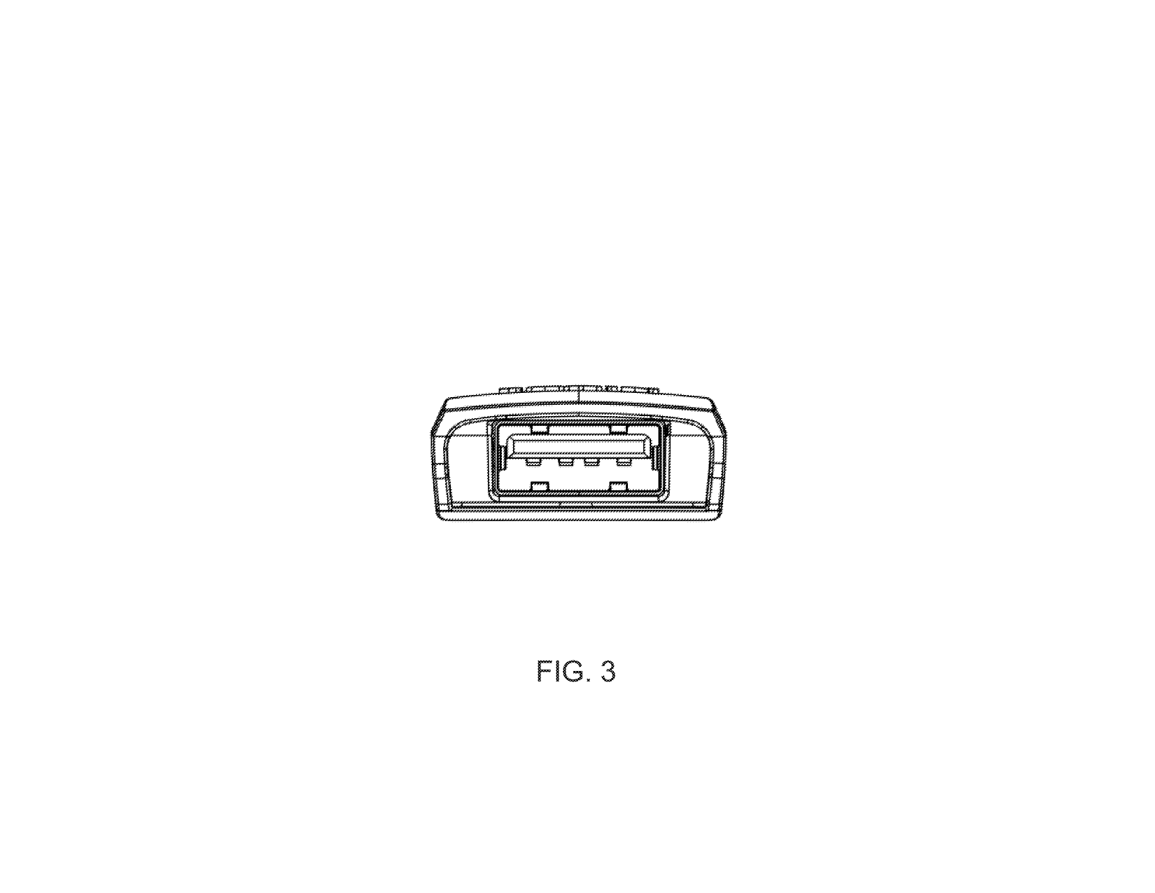

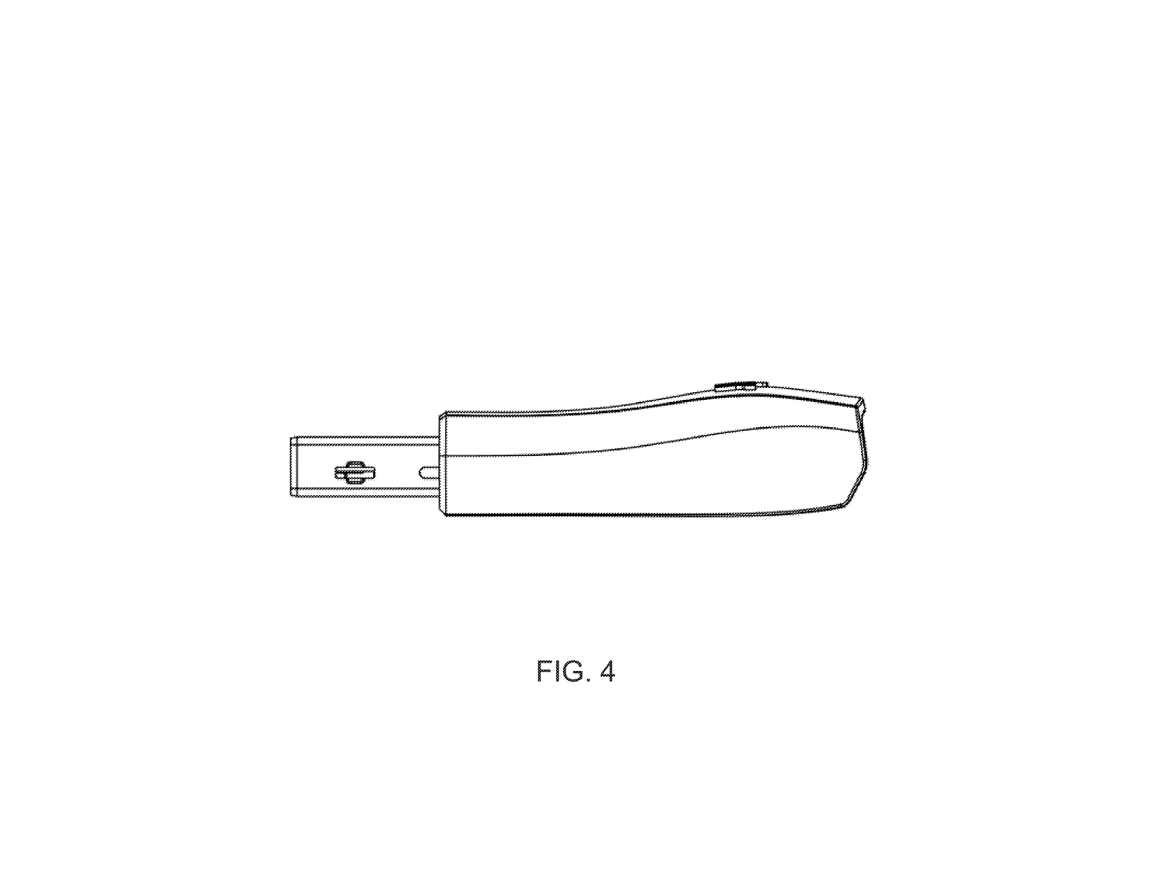

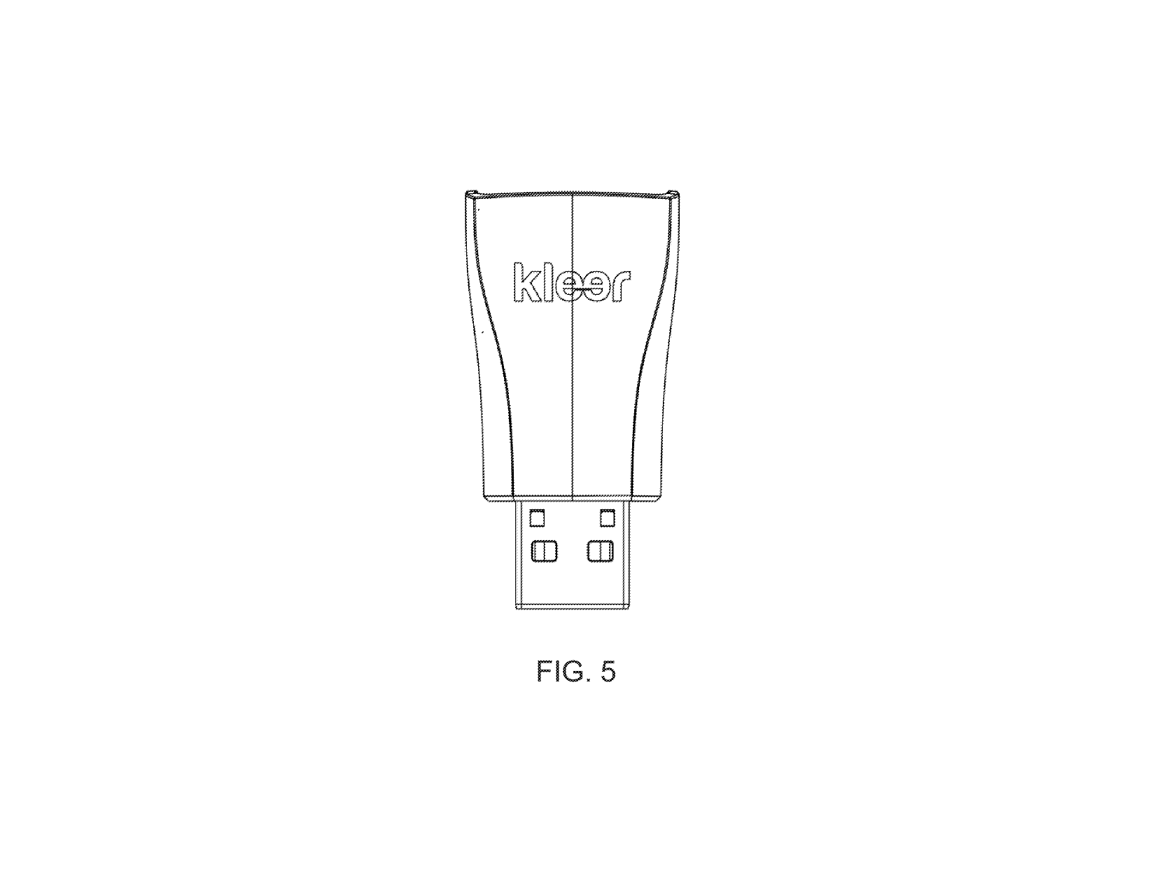

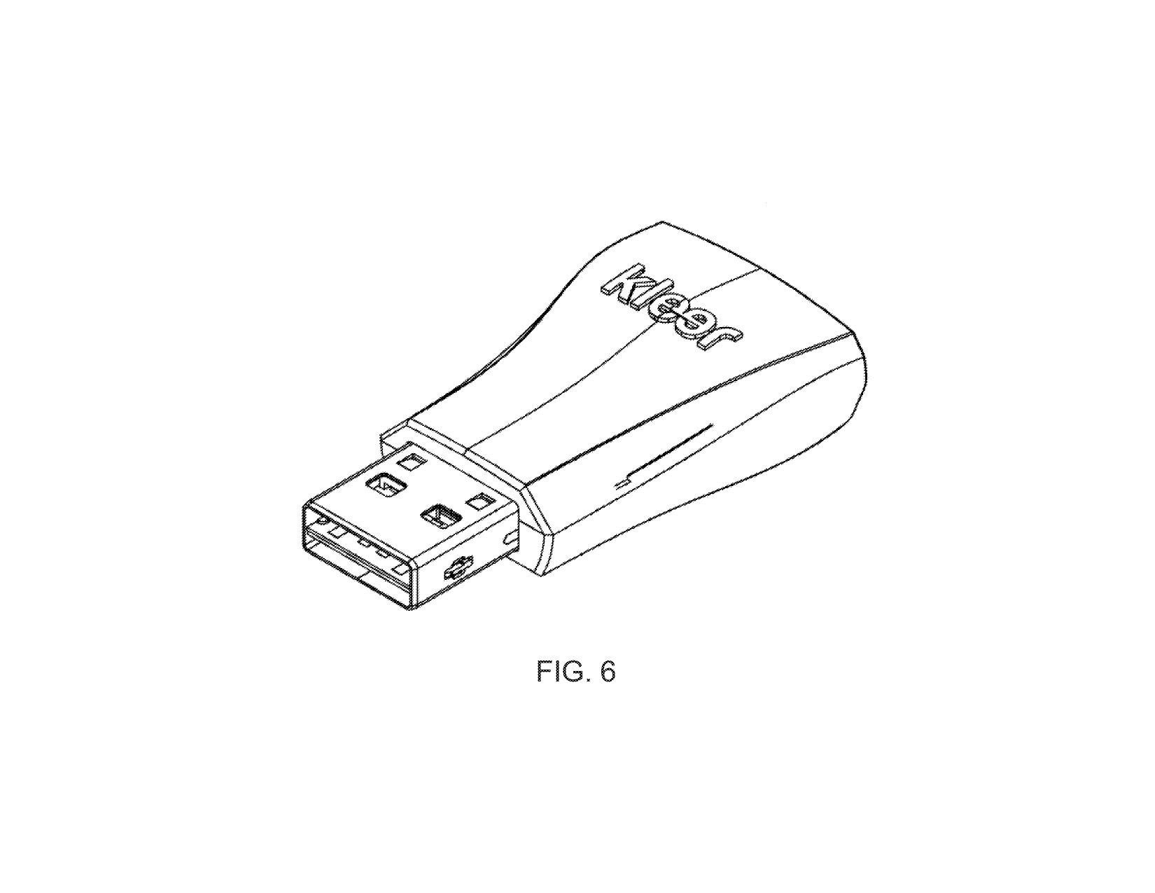

FIGS. 2-6 illustrate additional views of the USB storage drive 100 shown in FIG. 1. FIG. 2 is a front elevational view of the USB storage drive 100. FIG. 3 is a rear elevational view of the USB storage drive 100. FIG. 4 is a right side elevational view of the USB storage drive 100, the left side elevation view being mirror symmetric. FIG. 5 is a top plan view of the USB storage drive 100. FIG. 6 is a perspective view of the USB storage drive 100, as seen from the front, right, top side.

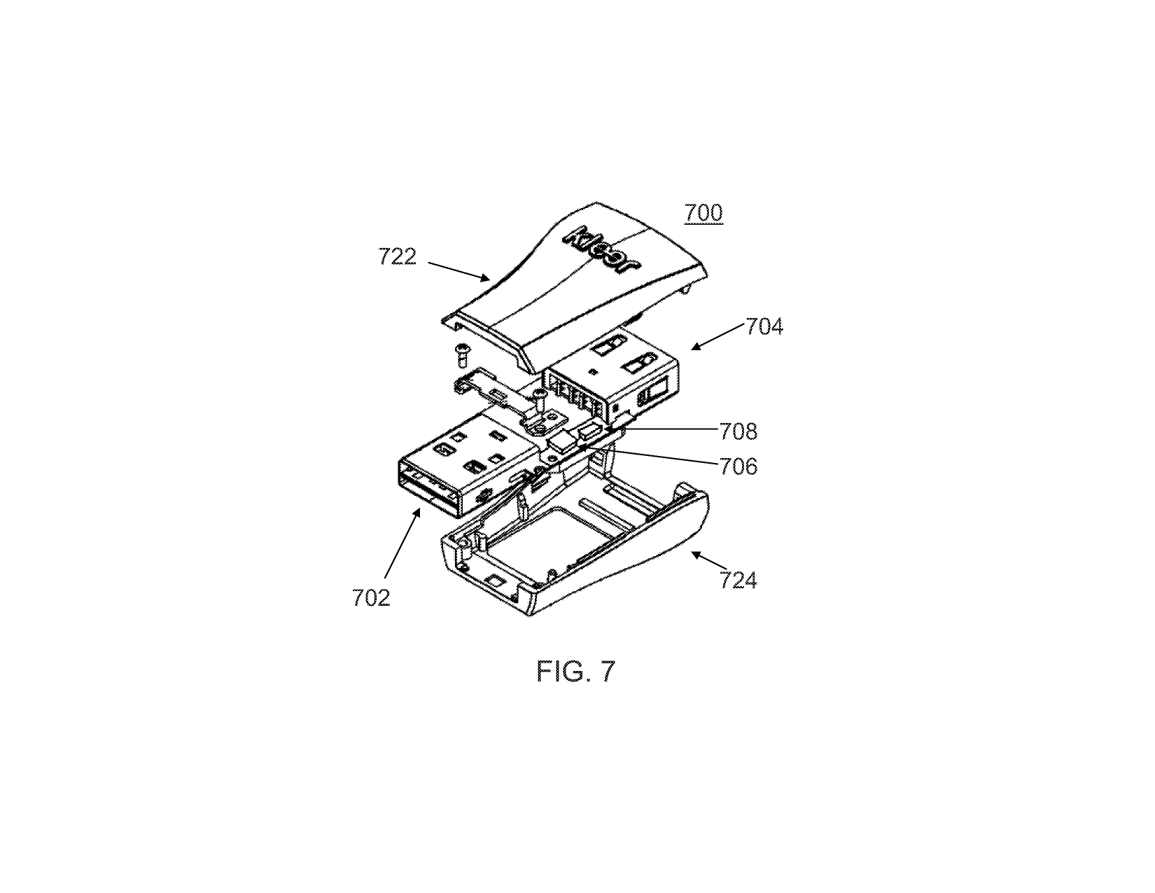

FIG. 7 is a diagram of an exploded view for the USB storage drive as shown in FIG. 1, according to one embodiment of the present invention. The USB storage drive 700 includes a USB male plug 702, at least one USB female receptacle 704, a controller 706, and at least one flash memory 708. In the example as shown in FIG. 7, the USB storage drive 700 is a USB flash drive, i.e. a USB data storage device using a flash memory to store data. In other embodiments, instead of a flash memory, the memory unit 708 can be a hard drive, a micro hard drive, or other non-volatile computer storages as appreciated by an ordinary skilled person in the art. FIG. 7 further shows the top and bottom housings 722 and 724 to cover and protect the electrical components.

FIG. 8 is a block diagram of the components of the USB storage drive as shown in FIG. 7. Inside of the USB storage drive 800, controller 806 serves as the central unit connecting to USB male plug 802, USB female receptacle 804, and flash memory 808. USB male plug 802 is configured to be connected to a USB port of a computer, or any devices having USB port connections, such as printers, game consoles, mobile phones, digital cameras. The USB storage drive 800 also draws power from the computer via the USB male plug 802 to run the drive. USB female receptacle 804 is adapted to be connected with another USB device (also referred to as an external USB device), such as another USB storage drive or a USB peripheral device. When USB storage drive 800 is powered through USB male plug 802, controller 806 detects and monitors whether USB female receptacle 804 is being connected with an external USB device. When no external USB device is connected to USB female receptacle 804, controller 806 serves as a USB mass storage controller. Controller 806 communicates with the computer via the connection of USB male plug 802 using the USB mass storage device class protocol. The computer recognizes the storage drive as a standard USB mass storage and reads/writes data on the storage drive based on the protocol.

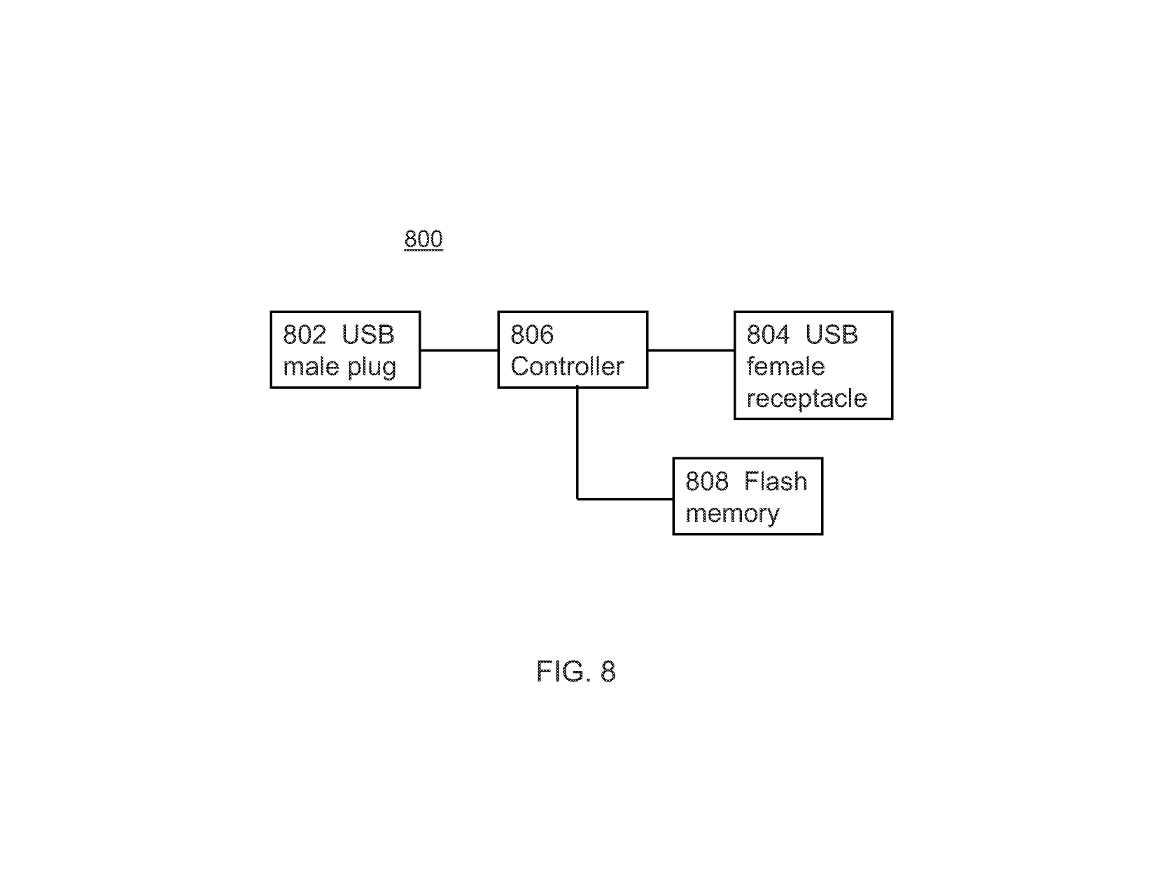

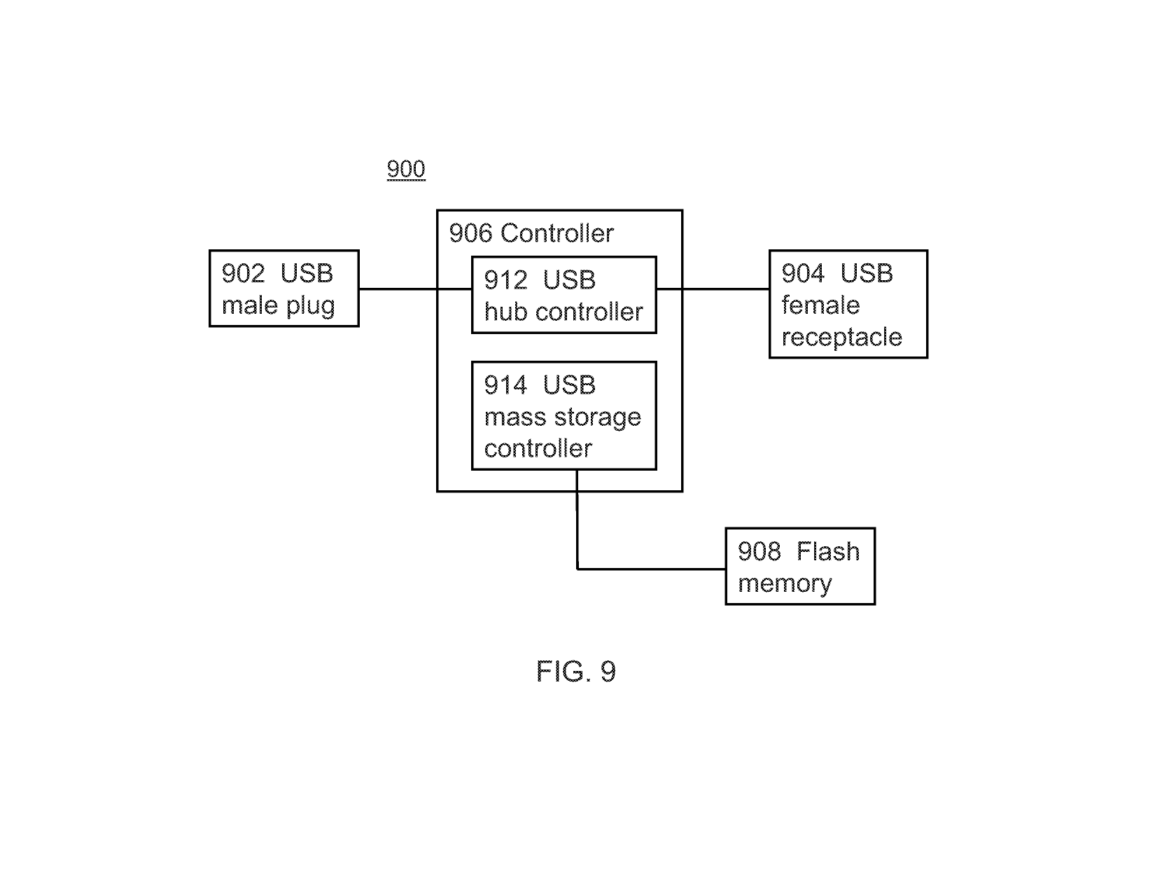

When there is an external USB device being connected to USB female receptacle, the controller may further serve as a USB hub controller. FIG. 9 is a block diagram of the components of a USB storage drive 900 when connected with an external USB device. Controller 906 serves as a USB hub controller 912 and a USB mass storage controller 914. The USB hub controller 912 expands a single USB connection to a computer or other host device into at least two USB connections with two downstream devices, including an external USB device and the USB storage drive 900 itself. The drive 900, as a first downstream device, has a flash memory 908 controlled by USB mass storage controller 914, connected to USB hub controller 912. The external USB device, as a second downstream device, is connected to USB hub controller 912 via USB female receptacle 904. The computer recognizes and communicates with both downstream devices via USB hub controller 912. In some embodiments, the computer or other host device may supply power to the downstream devices via USB hub controller 912.

In one embodiment, the USB hub controller 912 and the USB mass storage controller 914 may be implemented as distinct integrated circuits. In another embodiment, the USB hub controller 912 and the USB mass storage controller 914 may be implemented within a single controller integrated circuit.

In one embodiment, when an additional USB storage drive is connected to the USB female receptacle, the controller is configured to function as a USB interface for a virtual memory having a combined memory size as a summation of memory sizes of its own memory and the additional USB storage drive's memory. Therefore, the USB storage drive combines with the additional USB storage drive to form a USB storage drive having a bigger memory capacity.

In another embodiment, when the additional USB storage drive also has a USB female receptacle connected to one or more extra USB storage drives, the controller is configured to function as a USB interface for a virtual memory having a combined memory size as a summation of memory sizes of the USB storage drive, the additional USB storage drive and the extra USB storage drives. These USB storage drives are daisy chained via USB connections to form a USB storage drive having a bigger memory capacity.

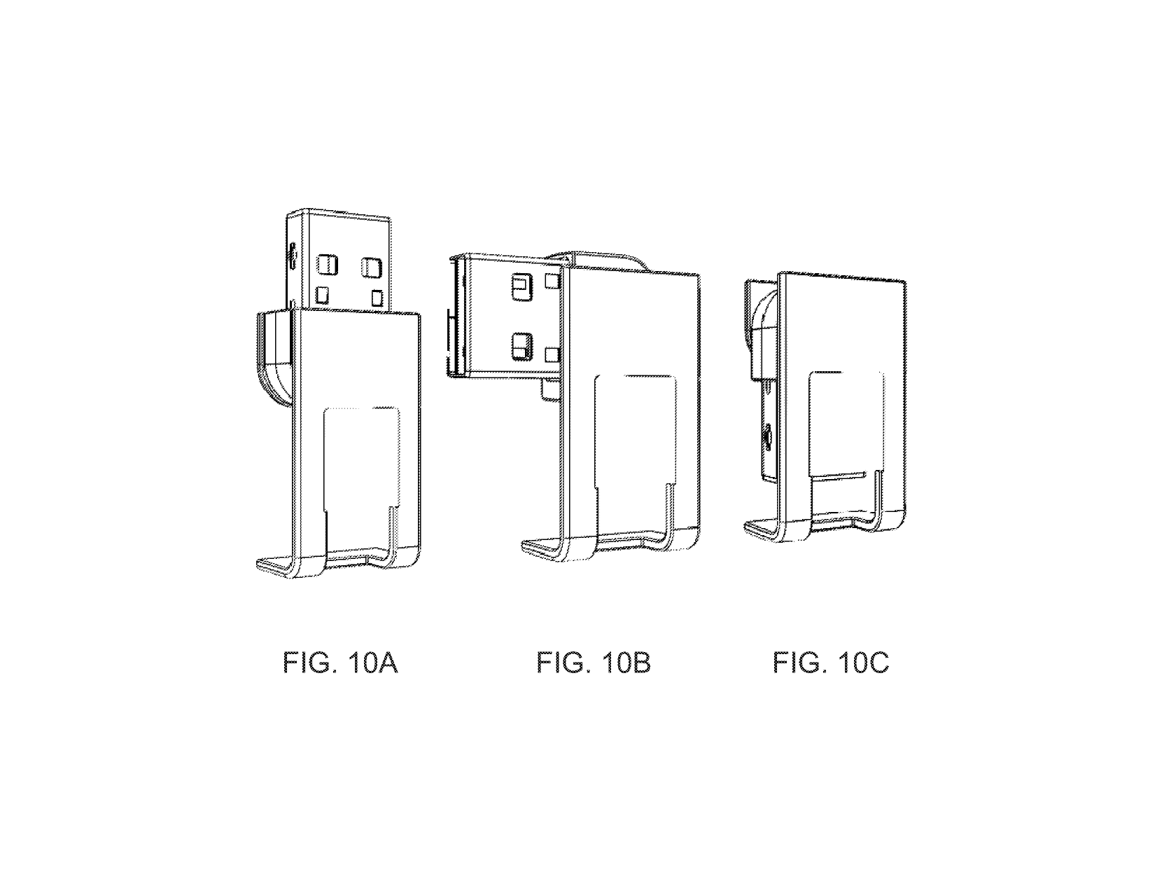

In one embodiment, the USB storage drive may include a swivel mechanism as shown in FIGS. 10A-10C. As shown in FIG. 10A, the USB male plug of the USB storage drive extrude out when the drive is in use. FIG. 10B shows the USB male plug in the middle of a swivel motion. FIG. 100 shows the USB male plug is swiveled to a protected position.

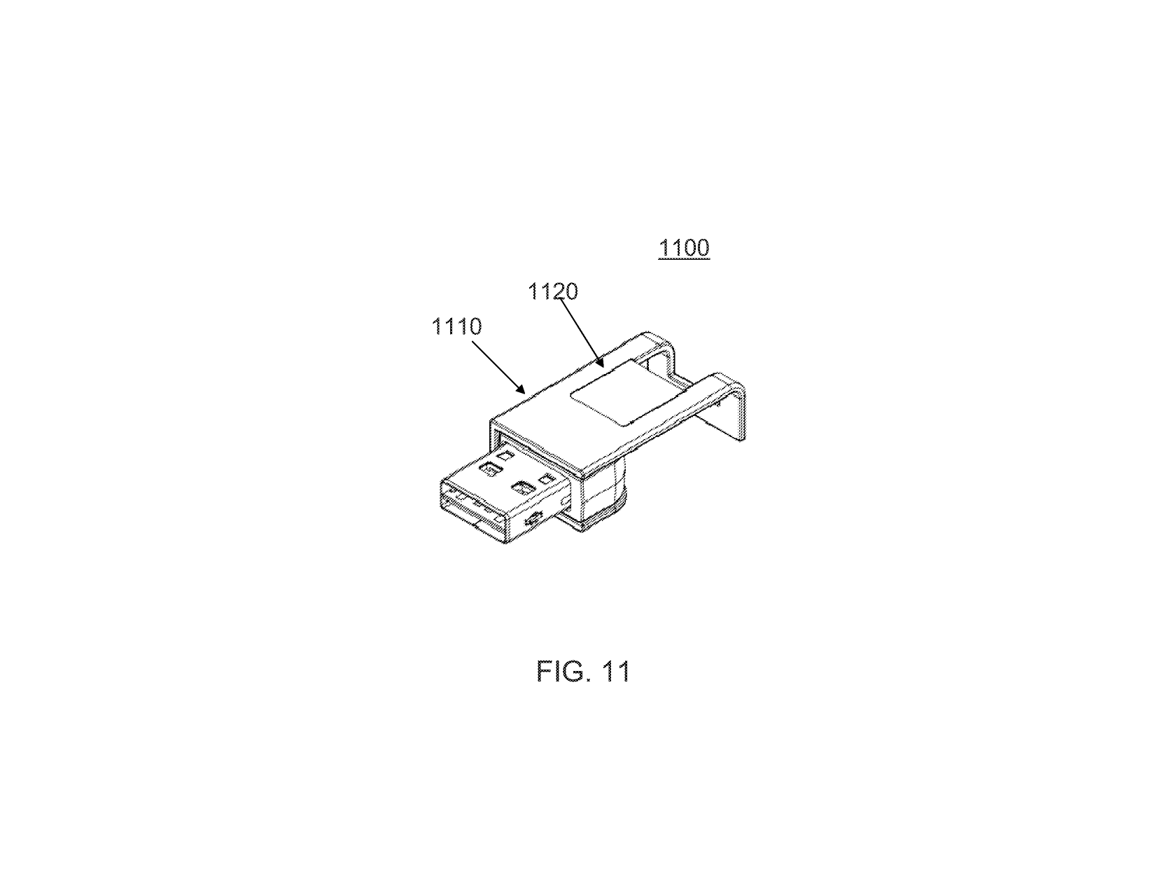

FIG. 11 is a perspective view of the USB storage drive 1100 with a swivel mechanism, as seen from the front, right, top side. Protection case 1110 offers protection of the USB male plug when it is rotated by 180 degrees into the protection case 1110. The protection case may be made of plastics or metal such as anodized aluminum. A replaceable pad 1120 is inserted in the middle of the surface of the protection case 1110. The replaceable pad 1120 can be replaced by removing the existing pad and inserting another pad. The replaceable pad 1120 may be customized to display certain logos, trademarks or signs. The drive 1100 may include a female receptacle (not shown) having similar functionalities as the female receptacle 904 of USB storage drive 900 as shown in FIG. 9. The drive 1100 may include a controller (not shown) having similar functionalities as the controller 906 of USB storage drive 900 as shown in FIG. 9.

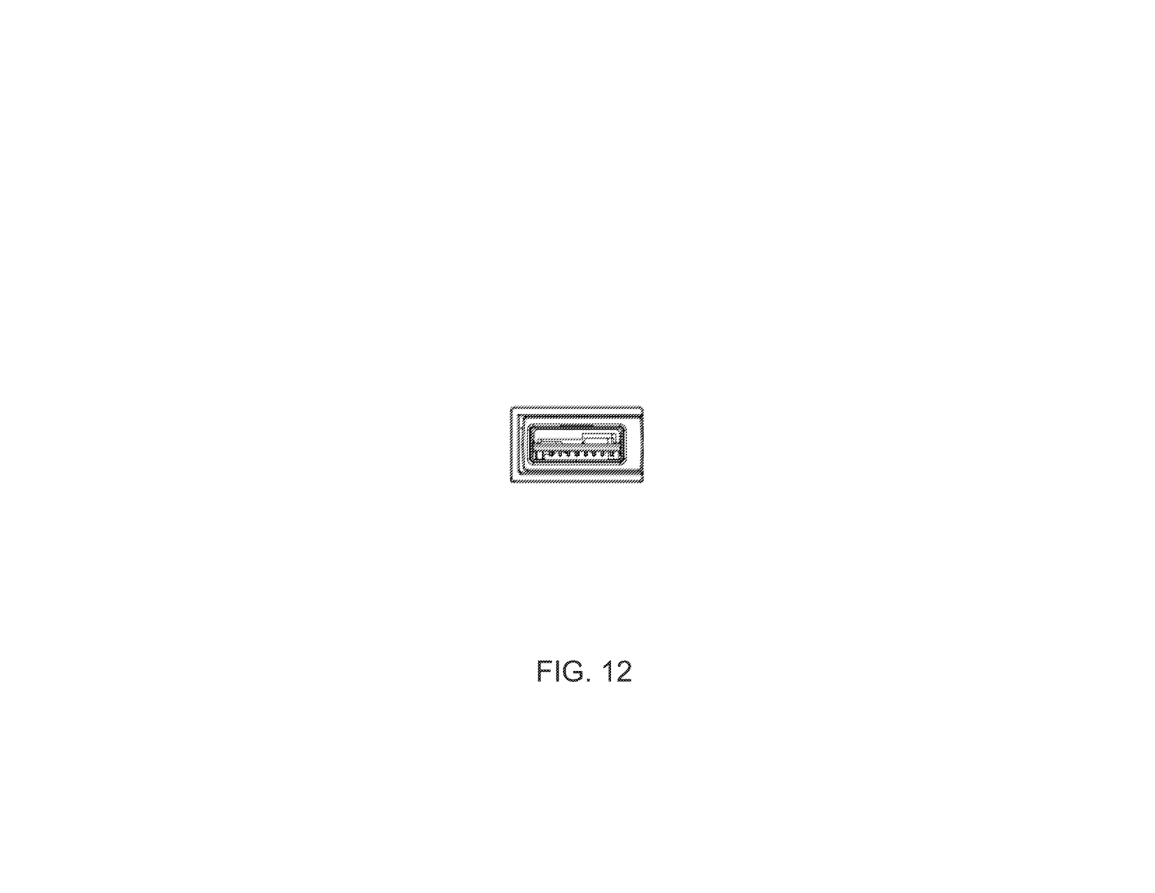

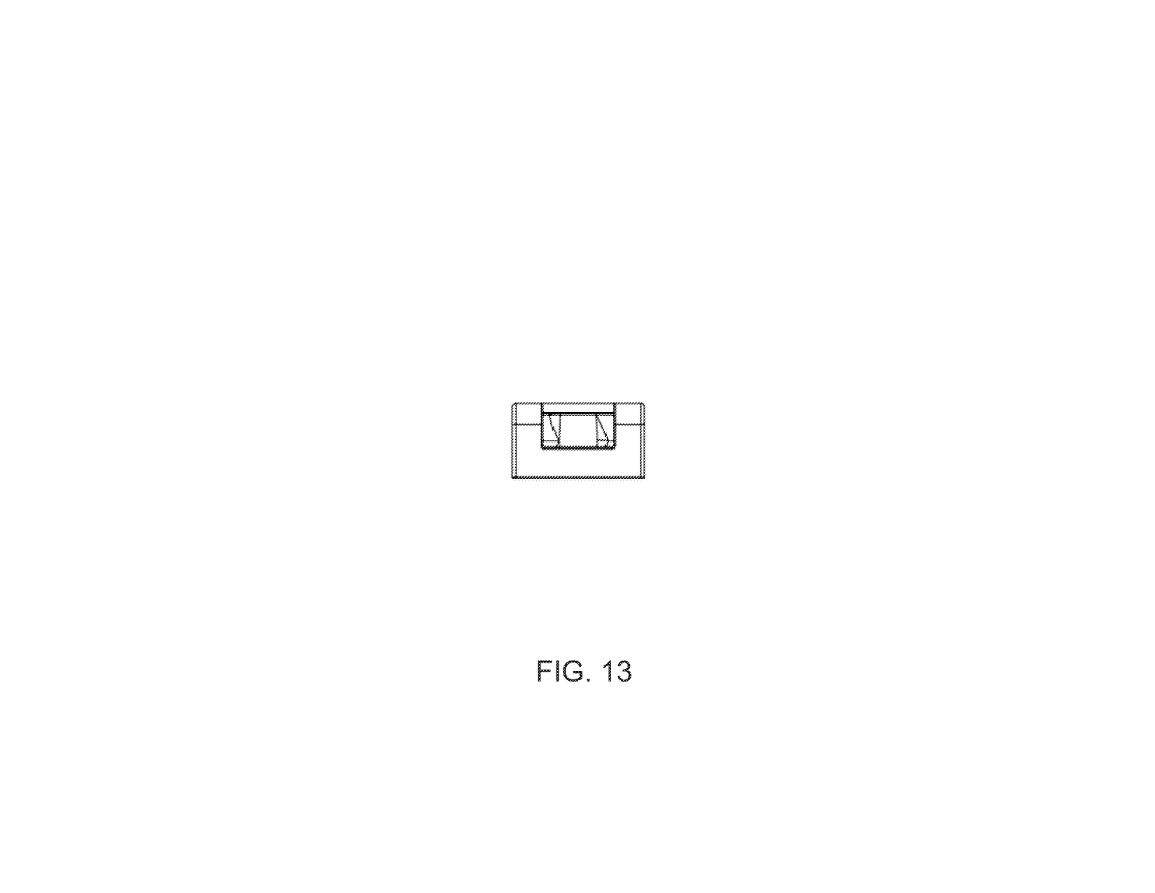

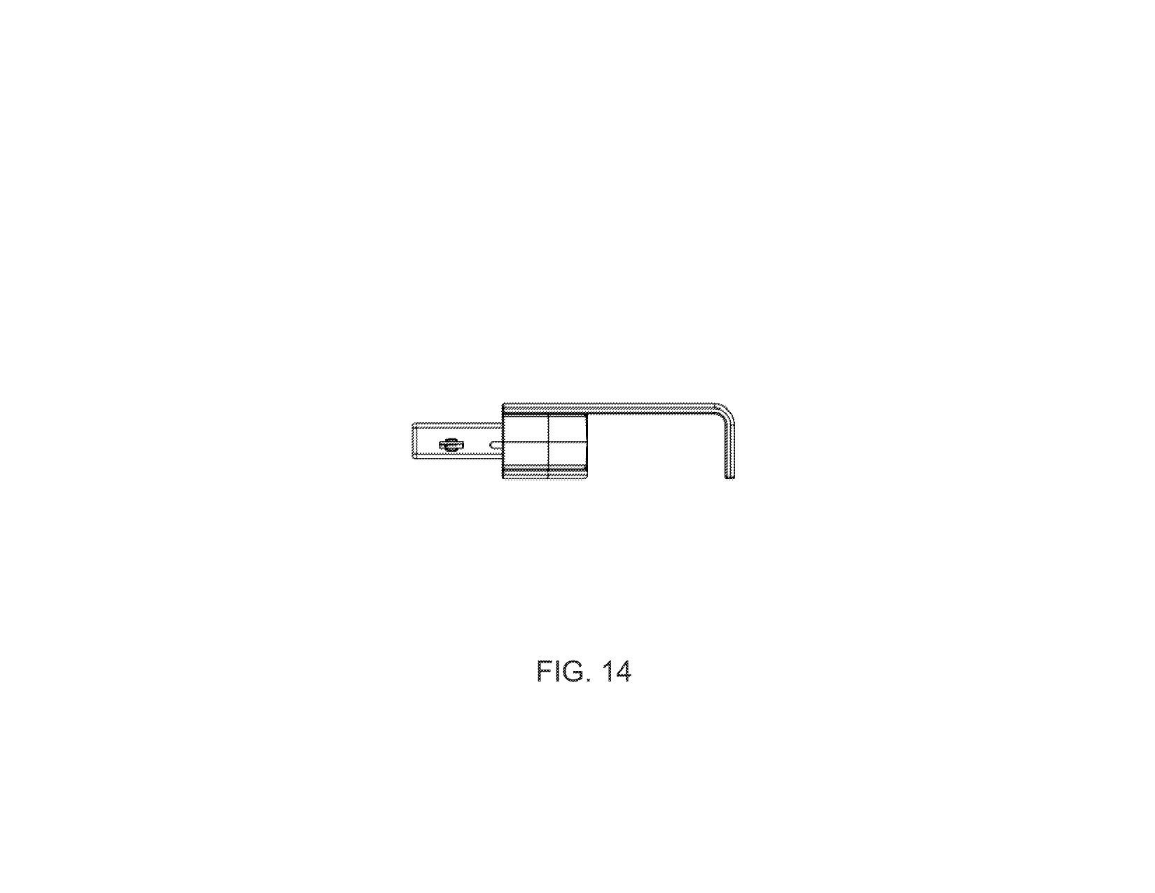

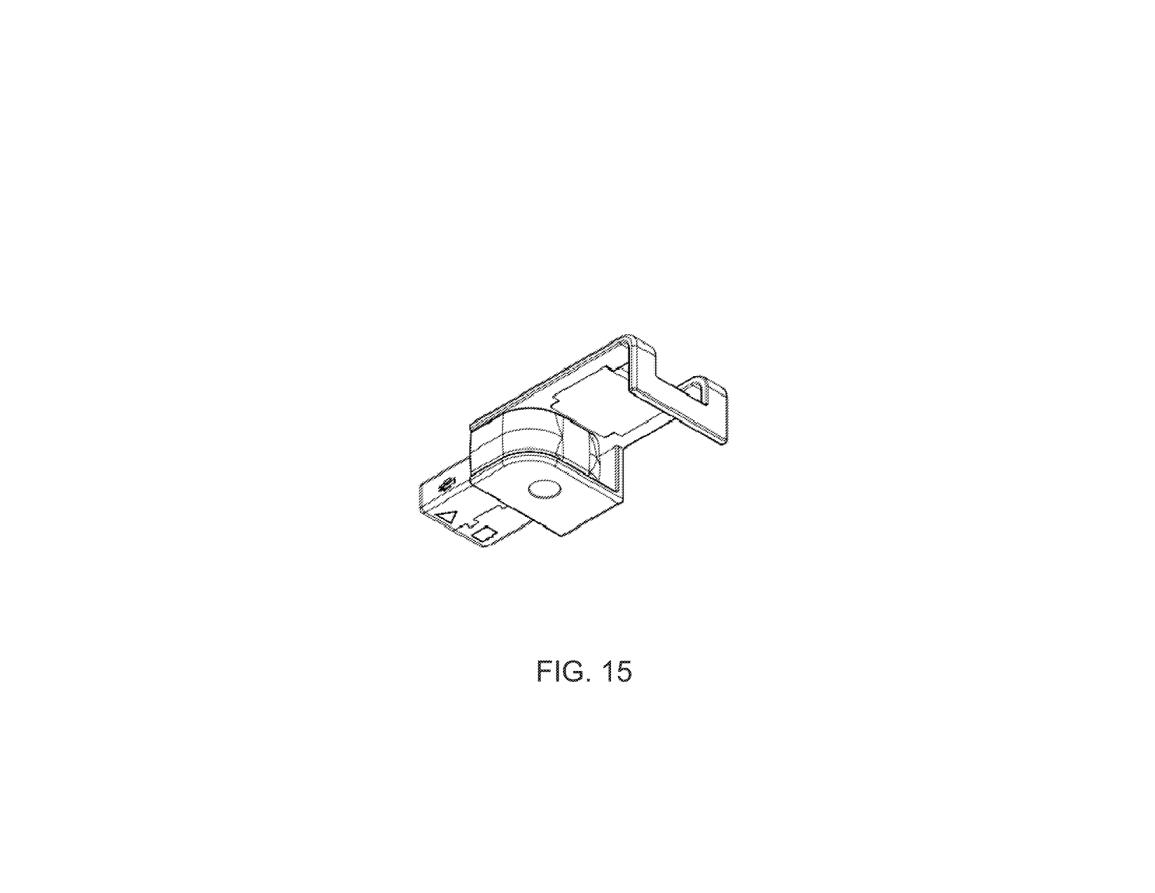

FIGS. 12-15 illustrate additional views of the USB storage drive 1100 shown in FIG. 11. FIG. 12 is a front elevational view of the USB storage drive 1100. FIG. 13 is a rear elevational view of the USB storage drive 1100. FIG. 14 is a right side elevational view of the USB storage drive 1100. FIG. 15 is a perspective view of the USB storage drive 1100, as seen from the rear, right, bottom side.

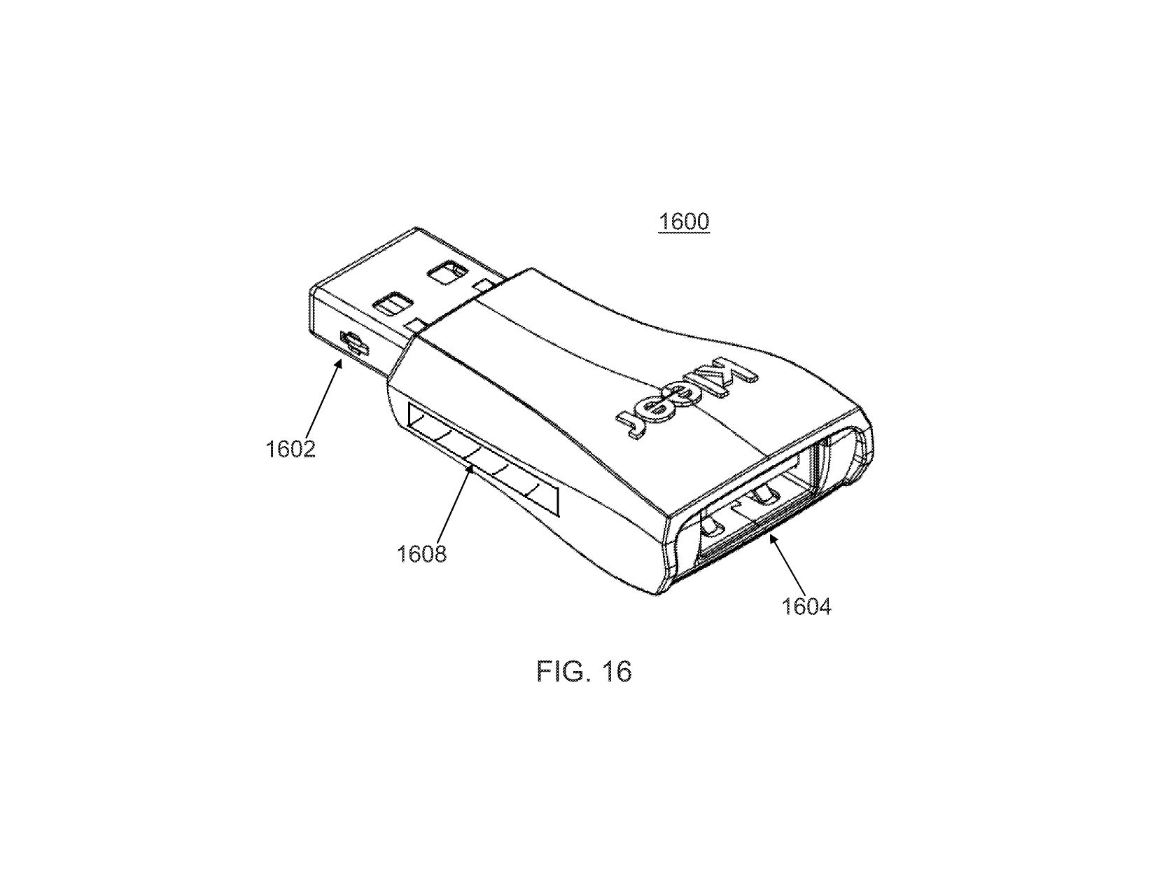

FIG. 16 illustrates an example of a USB memory card reader 1600 with a built-in pass-through hub connection, according to one embodiment of the present invention. The USB memory card reader 1600 includes a USB male plug 1602, at least one USB female receptacle 1604 and at least one memory card slot 1608. In the example as shown in FIG. 16, the USB female receptacle 1604 is located at the opposite end of where the USB male plug 1602 locates at the card reader 1600. In other embodiments, the USB female receptacle 1604 may be located on a lateral side, a top side, or a bottom side of the card reader 1600. In some embodiments, there may be more than one USB female receptacle to be connected with more than one USB peripherals. In the example as shown in FIG. 16, the USB male plug 1602 is a standard Type A USB male plug. In other embodiments, the USB male plug may be a Type B, Mini-A, Mini-B, Micro-A, Micro-B or any other types of USB 1.1, 2.0 or 3.0 male plug that an ordinary skilled person in the art readily utilizes on a USB plug. In the example as shown in FIG. 16, the USB female receptacle 1604 is a standard Type A USB female receptacle. In other embodiments, the USB female plug may be a Type B, Mini-A, Mini-B, Micro-A, Micro-B or any other types of USB 1.1, 2.0 or 3.0 female receptacle that an ordinary skilled person in the art readily utilizes on a USB receptacle. The memory card slot 1608 may accommodate and access one or more types of memory cards such as CompactFlash (“CF”), memory stick (“MS”), Secure Digital (“SD”), miniSD, rnicroSD card or any other types of memory cards, including cards such as game cards which often include memory

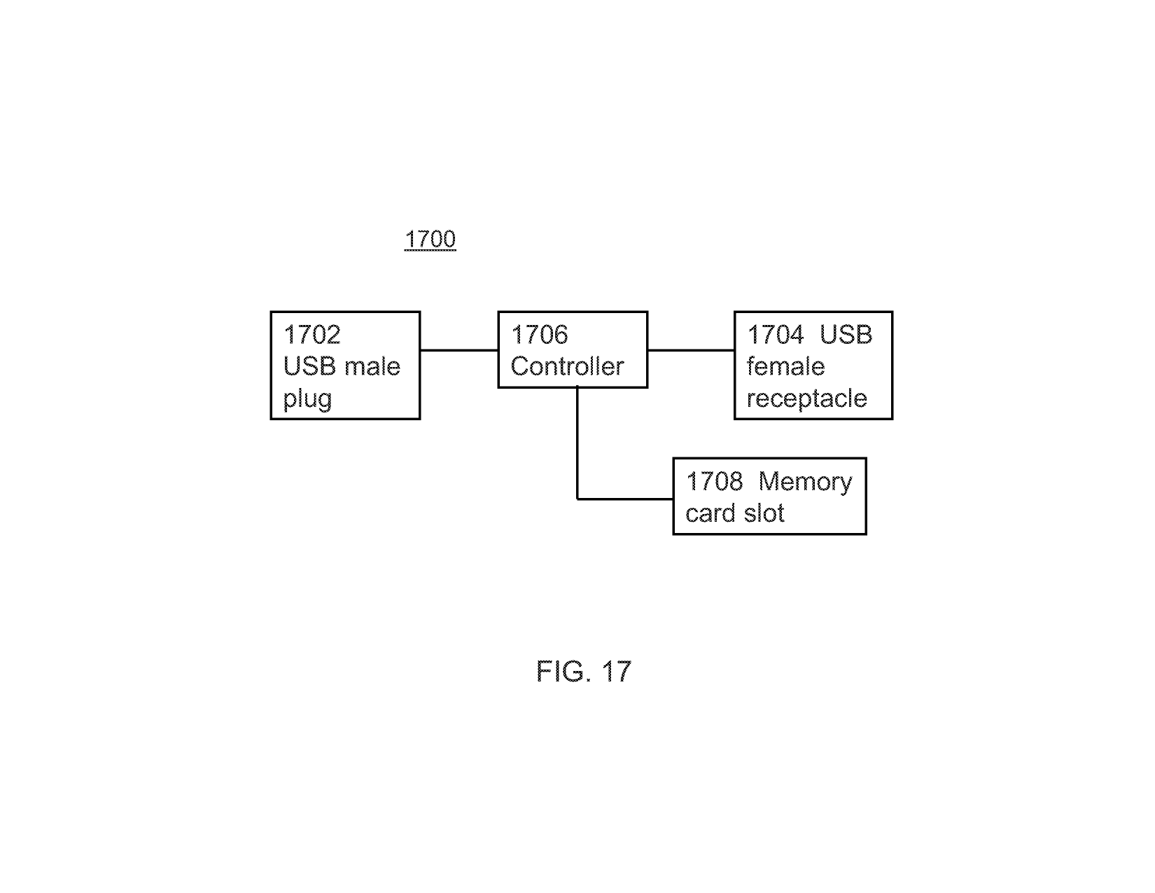

FIG. 17 is a block diagram of the components of a USB memory card reader, according to one embodiment of the present invention. Inside of the USB memory card reader 1700, controller 1706 serves as the central unit connecting to USB male plug 1702, USB female receptacle 1704, and memory card slot 1708. USB male plug 1702 is configured to be connected to a USB port of a computer, or any devices having USB port connections, such as printers, game consoles, mobile phones, digital cameras. The USB storage drive 1700 also draws power from the computer via the USB male plug 1702 to run the drive. USB female receptacle 1704 is adapted to be connected with another USB device (also referred to as an external USB device), such as another USB storage drive or a USB peripheral device. When USB storage drive 1700 is powered through USB male plug 1702, controller 1706 detects and monitors whether USB female receptacle 804 is being connected with an external USB device. When no external USB device is connected to USB female receptacle 1704, controller 1706 serves as a card reader controller. Controller 1706 communicates with the computer via the connection of USB male plug 1702 using the USB mass storage device class protocol. The computer access data on a memory card inserted in memory card slot 1708 via the card reader controller.

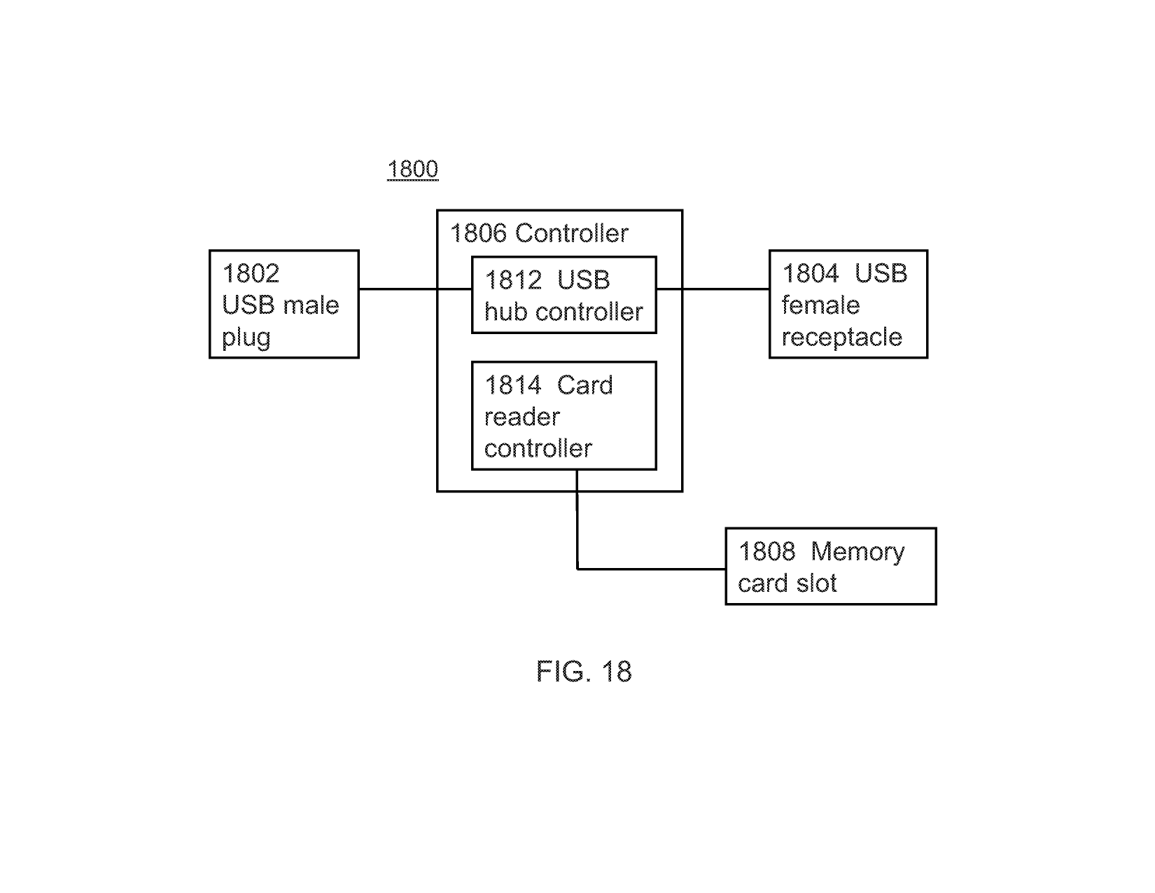

When there is an external USB device being connected to USB female receptacle, the controller may further serves as a USB hub controller. FIG. 18 is a block diagram of the components of a USB memory card reader 1800 when connected with an external USB device. Controller 1806 servers as a USB hub controller 1812 and a card reader controller 1814. The USB hub controller 1812 expands a single USB connection to a computer into at least two USB connections with two downstream devices, including an external USB device and the USB memory card reader 1800 itself. The drive 1800, as a first downstream device, has a memory card slot 1808 controlled by card reader controller 1814, connected to USB hub controller 1812. The external USB device, as a second downstream device, is connected to USB hub controller 1812 via USB female receptacle 1804. The computer recognizes and communicates with both downstream devices via USB hub controller 1812.

In one embodiment, the USB hub controller 1812 and the card reader controller 1814 may be implemented as separated integrated chips connected with electric circuit. In another embodiment, the USB hub controller 1812 and the card reader controller 1814 may be implemented within a single controller integrated chip.

In one embodiment, an additional USB storage drive is connected to the USB female receptacle, the controller is configured to function as a USB interface for a virtual memory having a combined memory size as a summation of memory sizes of the memory card inserted in the memory card slot and the additional USB storage drive. Therefore, the USB memory card reader combines the memory card and the additional USB storage drive to form a USB storage drive having a bigger memory capacity.

In another embodiment, the additional USB storage drive has a USB female receptacle connected to one or more extra USB storage drives, and the controller is configured to function as a USB interface for a virtual memory having a combined memory size as a summation of memory sizes of the memory card, the additional USB storage drive and the extra USB storage drives. Therefore, the USB storage drives are daisy chained via USB connections to the memory card reader to form a USB storage drive having a bigger memory capacity.

By way of example, a controller of the USB device of the present invention may be or include one or more programmable general-purpose or special-purpose microprocessors, microcontrollers, integrated chip, application specific integrated circuits (ASICs), programmable logic devices (PLDs), or a combination of such devices. The interconnect between such devices can include one or more buses, direct connections and/or other types of physical connections, and may include various bridges, controllers and/or adapters such as are well-known in the art. The interconnect further may include a “system bus”, which may be connected through one or more adapters to one or more expansion buses, such as a form of Peripheral Component Interconnect (PCI) bus, HyperTransport or industry standard architecture (ISA) bus, small computer system interface (SCSI) bus, universal serial bus (USB), or Institute of Electrical and Electronics Engineers (IEEE) standard 1394 bus (sometimes referred to as “Firewire”).

The present invention further contemplates other embodiments including any suitable wireless “flow” through device such as a wireless transmitter, receiver, and/or transceiver. Similar to the female plug enabling “flow” through of information, the wireless device enables information to be carried to external devices through a wireless connection. As will be appreciated, any wireless protocol or implementation is suitable.

The techniques introduced above can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

The teachings of the invention provided herein can be applied to other systems, not necessarily the system described above. The elements and acts of the various embodiments described above can be combined to provide further embodiments.

While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

What is claimed is:

1. A USB storage drive comprising:
a memory unit;
a USB male plug being adapted to be inserted into a USB port;
a USB female receptacle being adapted to connect to USB devices; and
a controller electrically coupled to the USB male plug, the USB female receptacle and the memory unit;
wherein the controller is configured to function as a USB mass storage controller when the USB female receptacle is not connected to any USB peripherals, and the controller is further configured to function as a USB hub controller when the USB female receptacle is connected to a USB peripheral.

2. The USB storage drive of claim 1,
wherein the memory unit has a first memory size;
wherein when an additional USB storage drive having a second memory size is connected to the USB female receptacle, the controller is further configured to function as a USB interface for a virtual memory having a combined memory size as a summation of the first memory size and the second memory size.

3. The USB storage drive of claim 2,
wherein when the additional USB storage drive has a USB female receptacle connected to one or more extra USB storage drives, the controller is further configured to function as a USB interface for a virtual memory having a combined memory size as a summation of memory sizes of the USB storage drive, the additional USB storage drive and the extra USB storage drives.

4. The USB storage drive of claim 1, wherein when the USB female receptacle is connected to a USB peripheral, the controller is further configured to function as the USB mass storage controller controlling a USB interface for the memory unit.

5. The USB storage drive of claim 1, wherein the memory unit is a flash memory, a hard drive, or a micro hard drive.

6. The USB storage drive of claim 1, wherein the USB male plug is a USB Type A male plug, a USB Type B male plug, a USB Mini-A male plug, a USB Mini-B male plug, a USB Micro-A male plug, or a USB Micro-B male plug.

7. The USB storage drive of claim 1, wherein the USB female receptacle is a USB Type A female receptacle, a USB Type B female receptacle, a USB Mini-A female receptacle, a USB Mini-B female receptacle, a USB Micro-A female receptacle, or a USB Micro-B female receptacle.

8. The USB storage drive of claim 1, wherein the USB mass storage controller and the USB hub controller is implemented in an integrated chip.

9. The USB storage drive of claim 1, further comprising a swivel mechanism and a protection case, wherein the swivel mechanism is configured to be able to rotate the USB male plug into the protection case.

10. The USB storage drive of claim 9, further comprising a replaceable pad inserted in the middle of a surface of the protection case.

11. A USB memory card reader comprising:
a memory card slot being adapted to accommodate and connect to a memory card;
a USB male plug being adapted to be inserted into a USB port;
a USB female receptacle being adapted to connect to USB devices; and
a controller electrically coupled to the USB male plug, the USB female receptacle and the memory card slot;
wherein the controller is configured to function as a card reader controller when the USB female receptacle is not connected to any USB peripherals, and the controller is further configured to function as a USB hub controller when the USB female receptacle is connected to a USB peripheral.

12. The USB memory card reader of claim 11,
wherein the memory card slot is adapted to connect to the memory card having a first memory size;
wherein when an additional USB storage drive having a second memory size is connected to the USB female receptacle, the controller is further configured to function as a USB interface for a virtual memory having a combined memory size as a summation of the first memory size and the second memory size.

13. The USB memory card reader of claim 12,
wherein when the additional USB storage drive has a USB female receptacle connected to one or more extra USB storage drives, the controller is further configured to function as a USB interface for a virtual memory having a combined memory size as a summation of memory sizes of the memory card, the additional USB storage drive and the extra USB storage drives.

14. The USB memory card reader of claim 11, wherein when the USB female receptacle is connected to a USB peripheral, the controller is further configured to function as the card reader controller controlling a USB interface for the memory card slot.

15. The USB memory card reader of claim 11, wherein the memory card slot is adapted to receive a CompactFlash card, a memory stick card, a Secure Digital card, a miniSD card, or a microSD card.

16. The USB memory card reader of claim 11, wherein the USB male plug is a USB Type A male plug, a USB Type B male plug, a USB Mini-A male plug, a USB Mini-B male plug, a USB Micro-A male plug, or a USB Micro-B male plug.

17. The USB memory card reader of claim 11, wherein the USB female receptacle is a USB Type A female receptacle, a USB Type B female receptacle, a USB Mini-A female receptacle, a USB Mini-B female receptacle, a USB Micro-A female receptacle, or a USB Micro-B female receptacle.

18. The USB memory card reader of claim 11, wherein the card reader controller and the USB hub controller is implemented in an integrated chip.

19. The USB memory card reader of claim 11, further comprising a swivel mechanism and a protection case, wherein the swivel mechanism is configured to be able to rotate the USB male plug into the protection case.

20. The USB memory card reader of claim 19, further comprising a replaceable pad inserted in the middle of a surface of the protection case.

21. The USB memory card reader of claim 11 wherein the memory card reader is adapted to work with a game card.

22. The USB memory card reader of claim 11, further including a second USB female receptacle being adapted to connect to USB devices, the controller electrically coupled to the second USB female receptacle capable.

23. A USB card reader comprising:
a card slot being adapted to accommodate and connect to a card;
a USB male plug being adapted to be inserted into a USB port;
a USB female receptacle being adapted to connect to USB devices;
a wireless transceiver facilitating wireless data communication via the USB card reader; and
a controller electrically coupled to the USB male plug, the USB female receptacle and the memory card slot;
wherein the controller is configured to function as a card reader controller when the USB female receptacle is not connected to any USB peripherals, and the controller is further configured to function as a USB hub controller when the USB female receptacle is connected to a USB peripheral.
